(19) United States
(12) Patent Application Publication
(10) Pub. No.: US 2017/0231439 A1
(43) Pub. Date: Aug. 17, 2017

(54) ASSEMBLY FOR A HYGIENIC COVER AND STORAGE

(71) Applicant: Julie Veard-Schaaf, Lorain, OH (US)

(72) Inventor: Julie Veard-Schaaf, Lorain, OH (US)

(21) Appl. No.: 15/045,920

(22) Filed: Feb. 17, 2016

(51) Int. Cl. A47K 13/14; G09F 3/00; A47K 13/04

(52) U.S. Cl. CPC A47K 13/14; A47K 13/04; G09F 3/00

(57) ABSTRACT

An assembly including a cover portion and a storage portion for hygienic use. The cover portion is a washable and reusable seat cover portion that is removably attachable to a mounting surface of a toilet seat section between a toilet cover and a top surface of a toilet bowl. The storage portion is configured to enable a hygienic storage and portability of the cover portion. A resilient member is disposed on an outer perimeter of the cover portion that is configured to create tension and enable a secure fastening of the cover portion to the mounting surface. An indicia on the cover portion is configured to help orient a positioning of the cover portion on the mounting surface. A matching indicia on the storage portion helps avoid confusion.

### CROSS- REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to a shielding assembly. More particularly, the invention relates to a shielding assembly that provides a barrier between a user and a mounting surface, such as a toilet seat, providing a cover portion for at least partially covering the mounting surface, marking the orientation of the cover portion with a marking portion, and fastening to the mounting surface with an outer perimeter having a resilient member, and further providing a storage portion for hygienic storage of the cover portion after use.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a toilet is a sanitation plumbing fixture used for the disposal of human urine and feces. The toilet can be designed for people who prefer to sit (by using a toilet pedestal) or for people who prefer to squat and use a squat toilet.

Typically, a toilet seat is engaged by a user while in a squatting/sitting position. This allows the colon to release the feces and urine more easily. The toilet seat sits proximal to the water line in the toilet bowl, and thus is susceptible to fecal matter and urine contamination.

Generally, replaceable covers for toilet seats have heretofore included paper or plastic devices designed to be discarded after a single use. Such disposable covers are usually effective for hygienic purposes in public restrooms, where each user will discard the cover after a single use.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate a top view of an exemplary shielding assembly, where FIG. 1A illustrates a solid indicia, and FIG. 1B illustrates a patterned indicia, in accordance with an embodiment of the present invention;

FIG. 2 illustrates a top view of an exemplary cover portion, in accordance with an embodiment of the present invention;

FIG. 3 illustrates a top view of an exemplary storage portion, in accordance with an embodiment of the present invention;

FIG. 4 illustrates a close up view of an exemplary marking portion in relation to an exemplary mounting surface, in accordance with an embodiment of the present invention; and

FIG. 5 illustrates a top view of a marking portion positioned on a storage portion, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003), Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that like the term ‘about,’ the term ‘substantially’ is a descriptive term commonly used in patent claims to avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”, e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware--for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of toilet seat covers that may be provided by preferred embodiments of the present invention. In one embodiment of the present invention, a shielding assembly helps to at least partially shield a user from contaminants on a mounting surface while the user rests on the mounting surface in a squatting or sitting position. The shielding assembly is configured to securely join with the mounting surface, such as a toilet seat, and also enable facilitated storage and portability for enhancing hygiene and convenience. Thus, the cover portion not only provides a restrictive barrier between an existing toilet seat and a user to inhibit contact with contaminants, but also is lightweight, portable, and fits securely on the toilet seat with minimal installation and no tools.

In some embodiments, the assembly may include a cover portion configured to at least partially cover the mounting surface. The mounting surface may include, without limitation, a toilet, a portable toilet, a floating toilet, a vault toilet, and a bidet. It is significant to note that such mounting surfaces require the user to rest on a seat while relieving excrement and urine. These mounting surfaces may also be heavily contaminated with bacteria, germs, urine, and fecal matter. Thus, the cover portion provides a restrictive barrier between an existing toilet seat and a user to inhibit contact with contaminants.

The cover portion may be shaped and configured to substantially cover a seat from the mounting surface. The cover portion may be sufficiently resilient so as to stretch over the mounting surface. In some embodiments, the cover portion may include a generally oval shape with an opening that is concentrically positons within an inner perimeter and an outer perimeter. The outer perimeter may include a resilient member configured to create tension on the cover portion to enable secure fastening of the cover portion to the mounting surface.

In some embodiments, the cover portion may further include a mount side that engages the mounting surface. The cover portion may further include an exterior side opposite the mount side, which is visible. The exterior side of the cover portion may include at least one cover indicia for decorative or identifying the cover portion.

In some embodiments, the cover portion may further include a rear end and a forward end. The rear end of the cover portion may be disposed behind a user during operation of the cover portion. The rear end may include an orientation towards the rear of the mounting surface. The front end may be disposed in front of the user during operation of the cover portion.

In some embodiments, the cover portion may be orientated on the mounting surface with a marking portion. The mounting portion may be disposed at the rear end or forward end of the exterior side, so as to indicate the orientation of the cover portion relative to the mounting surface. This may be efficacious for hygiene or for packing the cover portion into storage.

The assembly may further include a storage portion for hygienic storage of the cover portion after use. The storage portion may include a plurality of sidewalls having an outer surface and an inner surface. The outer surface may include at least one storage indicia for decorative and identifying functions. The storage portion may further include a cavity configured to contain the cover portion, especially when the cover portion is compacted into substantially the same shape as the cavity.

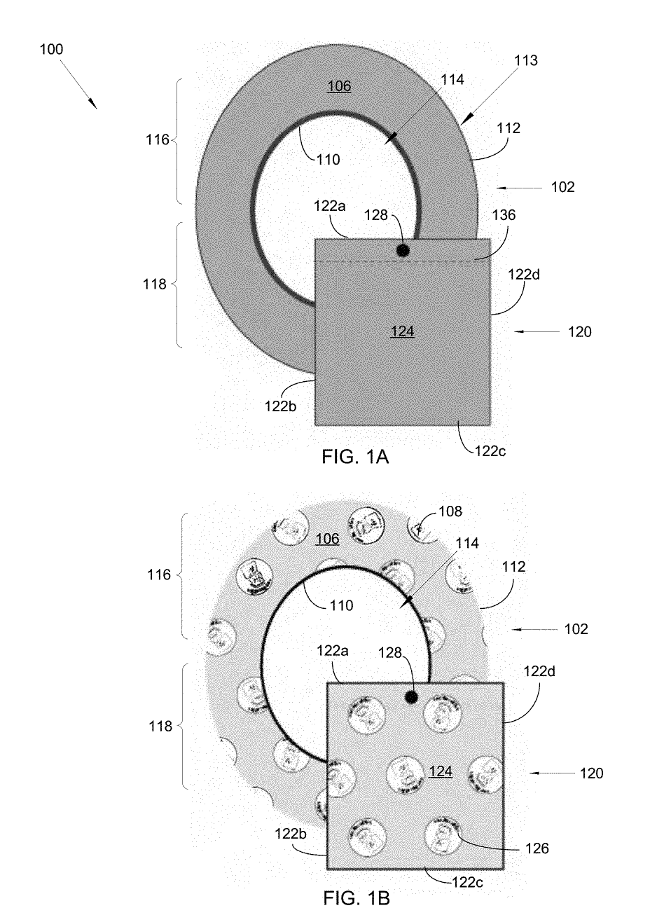

FIGS. 1A and 1B illustrate a top view of an exemplary shielding assembly, where FIG. 1A illustrates a solid indicia, and FIG. 1B illustrates a patterned indicia. In one aspect, a shielding assembly 100 is configured to at least partially shield a user from contaminants on a mounting surface while the user rests on the mounting surface in a squatting or sitting position. The mounting surface may include, without limitation, a toilet, a portable toilet, a floating toilet, a vault toilet, and a bidet.

Those skilled in the art will recognize that systems that form a protective barrier between a user and a toilet seat may include toilet paper and other light panles that overlay the toilet seat. However, these lighter panels are suseptible to shifting under the weight of the user, and thereby exposing contamination on the toilet seats. Other toilet seat covers include hard plastic children size toilet seats that fits on top of the toilet seat, but are not easily portable. Thus, the shielding assembly is configured to securely join with the mounting surface, such as a toilet seat, and also enable facilitated storage and portability.

Those skilled in the art, in light of the present teachings, will also recognize that a mounting surface, such as a toilet seat may require the user to rest comfortably and fully on the toilet seat while relieving excrement and urine. These mounting surfaces may be heavily contaminated with bacteria, germs, urine, and fecal matter. Thus, the shielding assembly may include a cover portion 102 that detachably attaches between the seat and the lid of a toilet. The cover portion not only provides a restrictive barrier between an existing toilet seat and a user to inhibit contact with contaminants, but also is lightweight, portable, and fits securely on the toilet seat with minimal installation and no tools.

In some embodiments, the cover portion may be comprised of plasticized material that is also bactericidal and fungicidal. In other embodiments, the cover portion may be comprised of a machine washable and reusable material that may also be bactericidal and fungicidal. The cover portion may include a marking portion for orientation during installation on the toilet. The cover portion may include at least one cover indicia 108 for decorative or identifying purposes. The assembly may further include a storage portion 120 to enable storage and portability of the cover portion when not in use. The storage portion is effective for improving hygiene and portability of the cover portion. The water/stain resistant storage pouch can be coated with an anti-bacterial composition to better help aide in improving hygiene.

In some embodiments, the cover portion 102 may be configured to at least partially cover the mounting surface. The cover portion may be shaped and configured to substantially cover a seat from a toilet. The cover portion may be sufficiently resilient so as to stretch over variously sized and dimensioned toilet seats, for example. In some embodiments, the cover portion may generally be oval or egg shape with an opening 114 that concentrically positions within an inner perimeter 110 and an outer perimeter 112 for a universal fit. In additional embodiments, an elastic material 132 may be sewn at the outer perimeter 112 to allow for a secure, universal fit.

As discussed above, the cover portion 102 installs easily and quickly onto the toilet seat, and is also removed with ease. The outer perimeter of the cover portion may include a resilient member 113 that is configured to create tension on the cover portion to enable secure fastening of the cover portion to the mounting surface. In one embodiment, the resilient member 113 may include an elastic ring that follows the path of a toilet seat outer edge. Though in other embodiments, the resilient member may include a drawstring 134 that may be pulled to form and adjust a snug fit between the cover portion and the mounting surface.

In some embodiments, the cover portion 102 may further include a mount side (not shown) that engages the mounting surface. The cover portion may further include an exterior side 106 that is disposed opposite the mount side. The exterior side is visible, and may include at least one cover indicia for decorative or identifying the cover portion. The cover indicia 108 may include, without limitation, images, text, logos, solid colors, patterns, and holographic. FIG. 1A illustrates a solid color for the cover indicia, while FIG. 1B illustrates a plurality of logos that make up the at least one cover indicia 108. Other uses may be closures such as snaps, buttons, magnets, velcro, drawstring. (Hope that is the answer you were looking for)??

In some embodiments, the cover portion 102 may further include a rear end 116 and a forward end 118. The rear end of the cover portion may be disposed behind a user during operation of the cover portion. The rear end may include an orientation guidance towards the rear of the mounting surface. For example, the rear end may align with the tank of the toilet. The front end of the cover portion may be disposed in front of the user during operation of the cover portion. For example, the front end may align with the front of the toilet seat.

In some embodiments, the assembly may further include a storage portion 120 for hygienic storage of the cover portion after use. The storage portion may also enable the cover portion to be compacted and carried in a pocket or purse. The storage portion 120 may include a plurality of sidewalls 122a-d having an outer surface 124 and an inner surface (not shown). The outer surface may include at least one storage indicia 126 for decorative and identifying functions. In one embodiment, the storage indicia substantially matches the cover indicia. The storage portion 120 may further include a cavity 136 configured to contain the cover portion, especially when the cover portion is compacted into substantially the same shape as the cavity 136. A fastener 128 may regulate access to the cavity.

FIG. 2 illustrates a top view of an exemplary cover portion 102. In some embodiments, the cover portion may be secured to a conventional toilet seat by stretching the outer perimeter around a correlating perimeter of the toilet seat and allowing the resilient member to from a tension around the toilet seat perimeter. The cover portion may be fabricated to form a resilient, stretchable material that enables easy fitting over a toilet seat. The cover portion may include an elastic material 138 sewn at the outer perimeter allowing for a secure and universal fit. The cover portion material may also be washable so as to be reused multiple times. Suitable materials for the cover portion may include, without limitation, polyurethane, nylon, and other polymer materials, and composites thereof.

In some embodiments, the cover portion 102 may be configured into a portable form and a usable form. The usable form of the cover portion is laid out flat, such that the generally oval shape overlays the toilet seat. The portable form of the cover portion may be rolled into a tubular form when not in use and configured in a tube (not shown) for storage between uses. Alternatively, the cover portion may be folded into a pack or merely compressed into a wad for storage in the cavity of the storage portion. In each of these portable forms of the cover portion, facilitated transport from one use to another in a pocket, purse or carrying case is possible.

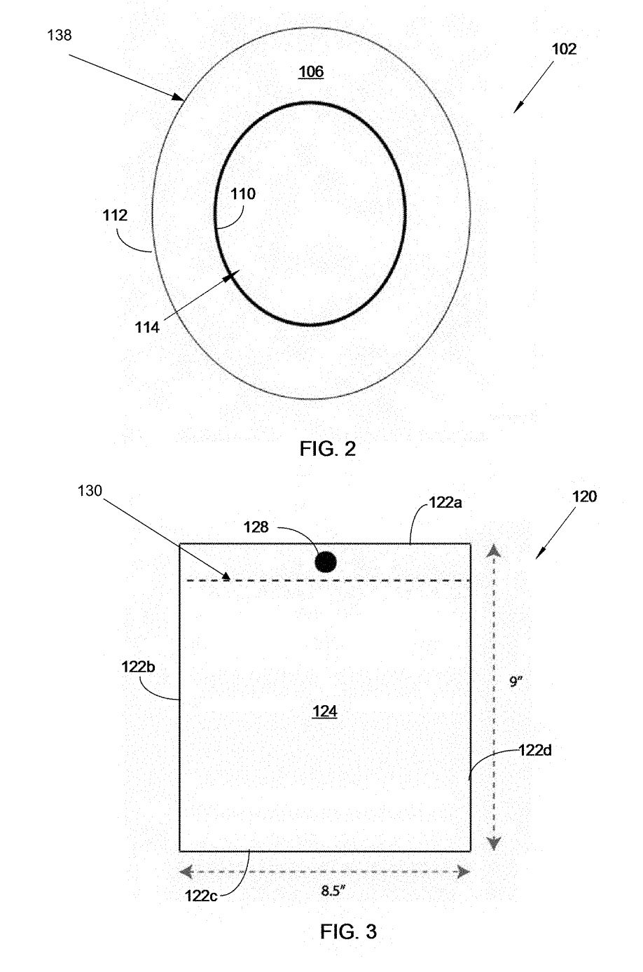

FIG. 3 illustrates a top view of an exemplary storage portion 120. In one aspect, the storage portion is useful for storing and carrying the cover portion between uses. The storage portion may be sized and dimensioned to receive the cover portion in a compacted form. In one embodiment, the storage portion is generally rectangular, having a height of about 9″ and a width of about 8½″.

The storage portion 120 may further include a cavity 136 that is sized and dimensioned to contain the cover portion, especially when the cover portion is compacted into substantially the same shape as the cavity. A storage opening 130 and a fastener regulate access to the cavity. The fastener may include, without limitation, a button, a hook and loop fastener, a magnet, and a friction fit mechanism. The storage portion can be of a hard substance or material, but defeats the purpose of being able to carry discreetly and unable to toss hard material into washer/dryer for convenience.

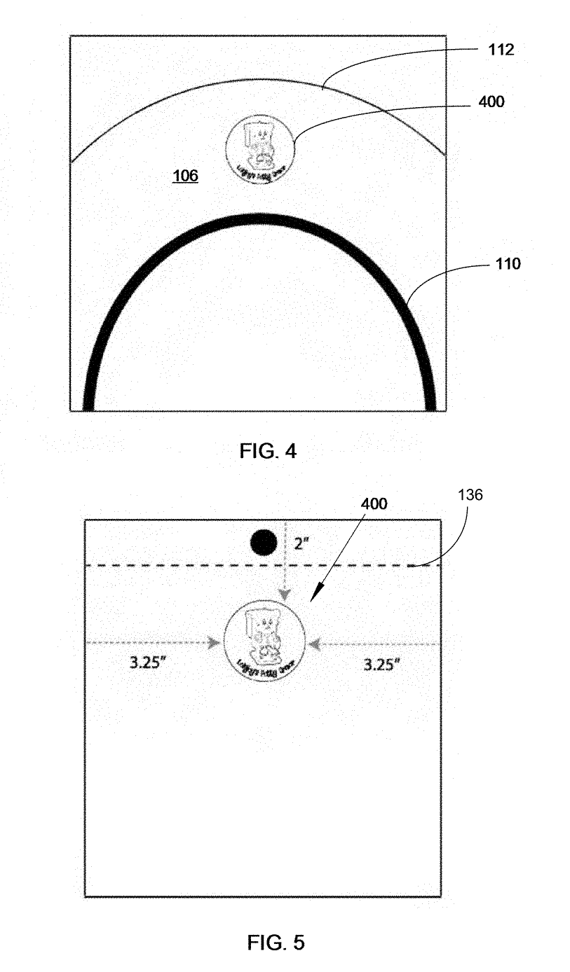

FIG. 4 illustrates a close up view of an exemplary marking portion in relation to an exemplary mounting surface. In one aspect, a marking portion 400 may be disposed on the exterior side of the cover portion. The marking portion may help orient a positioning of the cover portion on the mounting surface. The marking portion may be disposed at the rear end or forward end of the exterior side, so as to indicate the orientation of the cover portion relative to the mounting surface. This may be efficacious for hygiene or for packing the cover portion 102 into storage.

FIG. 5 illustrates a top view of a marking portion positioned on a storage portion 120. In one aspect, the marking portion 400 may include a detachable sticker. The marking portion may also include a generally circular logo. In any case, the marking portion may be disposed on the storage portion also, about 2″ from the storage opening and 3¼″ from the sidewalls of the storage portion.

In one alternative embodiment, the shielding assembly comprises feet covers to protect the user's feet in a squatting toilet. In another alternative embodiment, the resilient member around the outer perimeter of the cover portion is a draw string that enables adjustable fitting over variously sized toilet seats.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a shielding assembly that helps shield a user from contaminants on a mounting surface according to the present invention will be apparent to those skilled in the art. Various aspects of the invention have been described above by way of illustration, and the specific embodiments disclosed are not intended to limit the invention to the particular forms disclosed. The particular implementation of the shielding assembly that helps shield a user from contaminants on a mounting surface may vary depending upon the particular context or application. By way of example, and not limitation, the shielding assembly that helps shield a user from contaminants on a mounting surface described in the foregoing were principally directed to the shielding assembly that covers a toilet sea to shield a user from contaminants while the user rests on the mounting surface in a squatting or sitting position on the toilet seat, and a storage for the cover implementations; however, similar techniques may instead be applied to covering any surface that may be contaminated with germs or dangerous compositions, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An assembly comprising:
a cover portion, wherein said cover portion comprises a lightweight and portable seat cover portion that detachably attaches to a mounting surface of a toilet seat section between a toilet cover and a top surface of a toilet bowl, said cover portion further comprising;
a washable and reusable cover portion;
an inner perimeter;
an outer perimeter;
an opening concentrically positioned within said inner perimeter;
a rear end segment, wherein said rear end segment comprises an orientation guidance towards a rear portion of the toilet seat mounting surface;
a front end segment configured to align with a front portion of the toilet seat mounting surface;
a mount side section configured to engage the mounting surface;
an exterior side section comprising at least one cover portion indicia configured to be operable for identifying said cover portion; and
a resilient member disposed on said outer perimeter, said resilient member is configured to create tension on said cover portion to enable a secure fastening of said cover portion to the toilet seat mounting surface; and
a storage portion configured to enable a hygienic storage and portability of said cover portion, said storage portion comprising;
a water or stain resistant storage pouch;
an outer surface, in which said outer surface comprises at least one storage indicia disposed at a visible area of said outer surface, configured to be operable for identifying functions
a coating comprising an anti-bacterial composition configured to aide in said hygienic storage and portability of said cover portion;
an inner surface, wherein said inner surface comprises a cavity configured to accommodate a shape of said cover portion; and
an opening section configured to regulate access to said cavity, and in which said storage portion further comprising a fastener for securing said cover portion.

2. The assembly of claim 1, in which said at least one cover portion indicia comprises at least a marking portion configured to help orient a positioning of said cover portion on the mounting surface, wherein said mounting portion may be disposed at a rear end portion of the exterior side, so as to indicate the orientation of the cover portion relative to the mounting surface.

3. An assembly comprising:
a cover portion, wherein said cover portion comprises a lightweight and portable seat cover portion that detachably attaches to a mounting surface of a toilet seat section between a toilet cover and a top surface of a toilet bowl, said cover portion further comprising;
an inner perimeter;
an outer perimeter;
an opening concentrically positioned within said inner perimeter; and
a resilient member disposed on said outer perimeter that is configured to create tension on said cover portion to enable secure fastening of said cover portion to the mounting surface; and
a storage portion configured to enable a hygienic storage and portability of said cover portion, said storage portion comprising;
a water or stain resistant storage pouch; and
a coating comprising an anti-bacterial composition configured to aide in said hygienic storage and portability of said cover portion.

4. The assembly of claim 3, in which said cover portion further comprising a rear end segment configured to be disposed behind a user during an operation of said cover portion, wherein said rear end segment comprises an orientation guidance towards a rear portion of the toilet seat mounting surface.

5. The assembly of claim 4, in which said cover portion further comprising a front end segment configured to align with a front portion of the toilet seat.

6. The assembly of claim 5, in which said cover portion further comprising a mount side section that engages the mounting surface.

7. The assembly of claim 5, in which said cover portion further comprising an exterior side section having at least one cover portion indicia configured to be operable for identifying said cover portion.

8. The assembly of claim 7, in which said at least one cover portion indicia comprises at least one of an image, a text, a logo, a solid color, a pattern, and a holographic design.

9. The assembly of claim 7, in which said at least one cover portion indicia comprises at least a marking portion configured to help orient a positioning of said cover portion on the mounting surface, wherein said mounting portion may be disposed at a rear end portion of the exterior side, so as to indicate the orientation of the cover portion relative to the mounting surface.

10. The assembly of claim 7, in which said at least one cover portion indicia comprises at least a marking portion configured to help orient a positioning of said cover portion on the mounting surface, wherein said mounting portion may be removably disposed at a rear or forward end portion of the exterior side, so as to indicate the orientation of the cover portion relative to the mounting surface, and wherein said mounting portion comprises a detachable mounting portion sticker.

11. The assembly of claim 1, in which said storage portion further comprising a plurality of sidewalls.

12. The assembly of claim 11, in which said storage portion further comprising an inner surface.

13. The assembly of claim 12, in which said storage portion further comprising an outer surface.

14. The assembly of claim 13, in which said outer surface comprises at least one storage indicia disposed at a visible area of said outer surface, configured to be operable for identifying functions.

15. The assembly of claim 14, in which said at least one storage indicia comprises at least one storage indicia configured to substantially match said at least one cover portion indicia.

16. The assembly of claim 15, in which said at least one storage indicia configured to substantially match said at least one cover portion indicia further comprises a detachable marking portion sticker.

17. The assembly of claim 1, in which said storage portion further comprising a cavity configured to contain said cover portion.

18. The assembly of claim 17, in which said storage portion further comprising an opening configured to regulate access to said cavity, and in which said storage portion further comprising a fastener for securing said cover portion.

19. An assembly comprising:
means for detachably attaching to a mounting surface of a toilet seat section between a toilet cover and a top surface of a toilet bowl, said cover portion further comprising;
means for guiding a positioning of said attaching means towards a rear portion of the toilet seat mounting surface;
means for aligning with a front portion of the toilet seat mounting surface;
means for engaging the mounting surface;
means for identifying said cover portion; and
means for creating tension on said attaching means to enable a secure fastening of said attaching means to the toilet seat mounting surface; and
means for enabling a hygienic storage of said cover portion, said hygienic storage means comprising;
means for identifying functions;
means for aiding in said hygienic storage of said cover portion; and
means for accommodating a shape of said cover portion.

20. The assembly of claim 19, in which said hygienic storage means further comprising means for regulating an access to said accommodating means, in which said hygienic storage means further comprising a means for securing said attaching means.
